(19) United States
(12) Patent Application Publication
(10) Pub. No.: US 2015/0286835 A1
(43) Pub. Date: Oct. 8, 2015

(54) SECURED PRIVATE NETWORK AND STORAGE DEVICE

(71) Applicant: Avi Azoulai, Fremont, CA (US)

(72) Inventor: Avi Azoulai, Fremont, CA (US)

(21) Appl. No.: 14/675,742

(22) Filed: Apr. 1, 2015

Related U.S. Application Data
(60) Provisional application No. 61/975,803, filed on Apr. 5, 2014.

(51) Int. Cl. G06F 21/62; G08B 25/10; H04W 4/00; H04W 4/02; G06F 21/79; H04W 8/20

(52) U.S. Cl. CPC G06F 21/6218; G06F 21/79; H04W 8/205; H04W 4/008; H04W 4/021; G08B 25/10

(57) ABSTRACT

A compact, encrypted external flash drive device is configured for wired or wireless communication with laptop computers, mobile phones, tables or other mobile devices, to provide secure storage and transfer of documents, contacts, media files and other data to and from such mobile devices. The CardDrive device may include a microcontroller unit to control modules and features of the drive, including wireless interfaces, encryption/decryption, GPS location, and alert notifications. Multiple CardDrives may be configured to automatically share files when drives are within range of each other, forming a local private network of CardDrives. The CardDrive may act as secure, local sync and storage drive for designated devices, and may be configured and controlled by an application on the designated device. In some embodiments, a CardDrive may include two or more selectively deployable connectors for quickly and easily connecting to a variety of user devices.

### CROSS REFERENCE TO RELATED APPLICATIONS

This application claims priority under 35 U.S.C. §119 to U.S. Provisional Application Ser. No. 61/975,803 filed on Apr. 5, 2014, which application is incorporated by reference herein in its entirety. This application is also related to copending PCT Patent Application titled “Secured Private Network and Storage Device”, attorney docket number AVZ-001PCT, filed Mar. 31, 2015, which application is incorporated by reference herein in its entirety.

### TECHNICAL FIELD

This invention relates to digital storage devices, and in particular to devices and methods for securely storing and retrieving documents, audio, video, and other digital files.

### BACKGROUND

Unless otherwise indicated herein, the elements described in this section are not prior art to the claims and are not admitted to be prior art by inclusion in this section.

Online backup and cloud storage services have become increasingly popular with consumers and enterprises for storage of computer files and other important data and information. For example, online backup services such as Carbonite, Acronis, IDrive and Mozy allow a user to backup and retrieve files to remote servers over the Internet. Similarly, cloud services such as Box, Dropbox, Google Drive, iCloud and Microsoft Skydrive provides online backup and working access to digital files, where the digital files are stored on multiple, distributed virtual servers that are generally hosted by third parties.

While online backup and cloud storage services may provide the convenience of access from anywhere a user may access the Internet, they have inherent security risks due to the transmission of a user's data over public networks and storage in distributed servers controlled by 3^{rd} parties. For example, when data is distributed it is stored and transmitted between multiple locations it increases the risk of hacking and unauthorized physical access to the data. Also, a user is reliant upon the stability of and accessibility to remote 3^{rd} party service providers.

Personal external storage drives and devices are also known and commonly used, for example portable storage drives may be used on a wired or wireless local area network or connected to a user's computer to backup or retrieve files. Portable flash memory drives are also known, and have the convenience of a small form factor and portability for local storage of computer files, but most have limited USB interfaces that make it difficult or impossible to communicate with certain types of mobile phones, tablet computers and other computing devices. Also, existing flash memory drives have limited features for simple storage and retrieval of files from a connected computer, and do not employ any enhanced security, wireless communication, private networking or file management features that may be desirable for storing, managing and sharing important business and personal information and files.

Thus, there remains a need for a portable personal storage device capable of securely transferring and storing important documents, media files, and other data or files between drives, mobile devices and computers.

### SUMMARY

In some embodiments, a compact, encrypted external flash drive device (sometimes referred to herein as a “CardDrive”, or “drive”) is configured for wired or wireless communication with laptop computers, mobile phones, tables or other mobile devices, to provide secure storage and transfer of documents, contacts, media files (e.g., photos, audio, and/or video files) and other data to and from such mobile devices. In some embodiments, a CardDrive device may include two or more connectors, such as any combination of a USB connector (e.g., for connection to a laptop computer or other computer device or accessory), a micro USB connector (e.g., for connection to a Samsung Galaxy or other Android phone or tablet), a Lightning connector (e.g., for connection to an Apple iPhone or iPad), and/or other desired connector or port. In some embodiments, one or more of the connectors are integrated with the device, such that each may be stowed within the device and selectively deployed for use, e.g., using a hinge or slider mechanism to selectively deploy or stow each connector.

In some embodiments, a CardDrive may include a microcontroller unit (or “micro controller”, or “MCU”), a flash memory, an encryption/decryption module for securely storing files, a power management module, and an I/O interface. In some embodiments, a CardDrive may also include a wireless transceiver, a GPS module, and an alert notification module. The GPS module may provide for tracking the location of a device, e.g., if it is lost or stolen and/or for incorporating location information into file storage or transfer logs. The alert notification module may provide real time alert notification, e.g., by sending a signal over wired or wireless networks to the user (e.g., by email, text message, or using an associated mobile application), in response to activities such as an attempts to access data or files on a device, a completed file transfer, detection of an associated CardDrive device or authorized user within wireless range. Various other desired alerts or notifications may be configured, and automated or selective responses or actions such as blocking further access may be configured. In some embodiments, automatic synchronized mirror backup routine may be used to automatically backup all of the data stored on one card to another card, e.g., for extra security when the two cards are connected or in wireless range. Secured wireless communication between CardDrives and associated mobile devices, e.g., using short range wireless communication protocols, may create a local, secured private network for transfer and management of digital files.

In some embodiments, a CardDrive may include a wireless transceiver for wirelessly communicating with, and transferring files to and from, a computer or mobile device, for example using a short range wireless communication protocol such as Bluetooth, infrared, Zigbee, WiFi, or other wireless communication protocols. In some embodiments, multiple CardDrive devices are configured to communicate with each other, e.g. to share files or other data between designated devices. In some embodiments, a CardDrive is configured for wired or wireless communications over a local, secure private network of multiple authorized CardDrives, allowing users to share files, music, videos, etc. with each authorized user on the private network. In some embodiments, a CardDrive or network of wirelessly connected CardDrives can also allow direct mobile phone to mobile phone encrypted and secured communication (e.g., voice/text/email) via the private CardDrive network.

In some embodiments, a mobile application is provided and may be used to configure and control operation of a CardDrive device, for example to view, play or transfer documents, media files or photos stored on the card rive into the corresponding mobile device, or to access and attach a stored file to any email or text in real time from the mobile device. In some embodiments, CardDrive devices described herein provide for rapid and secure transfer of documents, photos, music, and video between a user's computer and mobile device (e.g., smart phone or tablet). Currently users are unable to attach any documents they have stored on their USB flash drive into a mobile phone when sending an email or text from their mobile phone. The CardDrive device can also download any photos or documents from the mobile phone or mobile device into the flash drive in an encrypted format.

In some embodiments, a multi function CardDrive device can be used as a regular USB flash drive device similar to others sold in the market, but may also function as a flash drive for mobile devices who do not currently have a USB connector option or suitable software to allow access to externally stored files, e.g. for email or text attachment.

CardDrive devices described herein may also be used to transfer content such as photos or documents stored on a phone and into the CardDrive for printing or for any other use elsewhere and can also function as an external back up storage device to the mobile phone, allowing the user to keep private and sensitive information on the user private flash drive and bypass other programs such as iTunes, which regularly backs up user sensitive and private photos and documents over public networks and/or on servers cloud servers that may be in danger of breach by hackers. Such local and secure storage on a CardDrive will provide protection, security and privacy to users who may loose sensitive private information if their phone is lost or stolen. In some embodiments, a mobile application associated with the CardDrive may also incorporate an auto-delete feature on all photos and information stored only on the phone in case the phone is lost or stolen. In such event, all photos, documents or contacts are still safely stored on the external flash drive. This device may also be password protected in addition to being encrypted.

In some embodiments, a CardDrive has two or more modes or options (e.g., via software selection from the mobile application) for storage that user can select, for example an encrypted mode and a non-encrypted mode. In the encrypted mode, transfer or reading or viewing of any photos or information can only be done using another mobile device that contains the user's encryption/decryption application, security keys, and/or other encryption information (e.g., device serial number or unique device ID) associated with the user's personal mobile phone or computer (e.g., for storage and retrieval of confidential documents). In some embodiments, the serial number and associated encryption key and password of the mobile device is added and programmed into the CardDrive's authorized list of devices for that specific user, such that no communication between the Card Drive and the mobile device can occur without the mobile device ID being programmed into the CardDrive as an authorized device. Such security measures may be employed to ensure that only authorized devices communicate with the CardDrive. In some embodiments, a non-encrypted mode may be selected and/or configured, for example to allow designated files and other data stored on the device to be transferred or shared with any mobile device or phone (e.g., including those that do not have a corresponding user encrypted software application loaded into it).

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings.

FIG. 1A is a front perspective view illustration of a CardDrive device according to one or more example embodiments.

FIG. 1B is a front perspective view illustration of a CardDrive device of FIG. 3A, with a connector deployed.

FIG. 2 is a schematic diagram of functional modules of a CardDrive device according to an example embodiment.

FIG. 3 is a schematic diagram of functional modules of a CardDrive device according to another example embodiment.

FIG. 4A is a front view illustration of a CardDrive device with multiple connectors deployed, according to an example embodiment.

FIG. 4B is a back view illustration of the CardDrive device of FIG. 4A, according to an example embodiment.

FIG. 4C is a top view illustration of the device of FIG. 4A, according to an example embodiment.

FIG. 4D is a left side view illustration of the device of FIG. 4A, according to an example embodiment.

FIG. 4E is a right side view illustration of the device of FIG. 4A, according to an example embodiment.

FIG. 4F is a bottom view illustration of the device of FIG. 4A, according to an example embodiment.

FIG. 5A is a front view illustration of a CardDrive device engaged with a mobile phone according to an example embodiment.

FIG. 5B is a front view illustration of a CardDrive device engaged with a tablet device according to an example embodiment.

FIG. 6A is a perspective view illustration of a wireless CardDrive device according to an example embodiment.

FIG. 6B is a front view illustration of the example CardDrive device of FIG. 6A.

FIG. 7A is a perspective view illustration of a CardDrive device according to another example embodiment.

FIG. 7B is a front view illustration of the example CardDrive device of FIG. 7A.

FIG. 8 is a schematic illustration of a wireless CardDrive device in communication with other devices according to an example embodiment

FIG. 9 is a schematic illustration of a network of CardDrive devices for sharing files between CardDrive devices.

FIG. 10A is a perspective view illustration of a cradle for a CardDrive device according to an example embodiment.

FIG. 10B is a perspective view illustration of the cradle of FIG. 10A, in use with a CardDrive device.

FIG. 11A is a front view illustration of a CardDrive device according to another embodiment.

FIG. 11B is a bottom view illustration of the example CardDrive device of FIG. 11A.

FIG. 11C is a side view illustration of the example CardDrive device of FIG. 11B.

FIG. 12 is a perspective front view illustration of another example embodiment of a flash storage device.

FIG. 13 is a front view illustration of another example embodiment of a CardDrive device having a plurality of connectors.

FIG. 14 is a schematic illustration of functional modules of a mobile application for use to configure and communicate with a CardDrive device, according to an example embodiment.

FIG. 15 is a flow chart of an example method of storing or transferring files to and from a CardDrive device.

FIG. 16 is a flow chart of an example method of performing an automatic wireless backup between two CardDrives in a private network.

FIG. 17 is a flow chart of an example method of alert notification according to an example embodiment.

FIG. 18 is a flow chart of an example method of communicating between a CardDrive and an authorized mobile device according to an example embodiment.

FIG. 19 is a flow chart of an example method of viewing or transferring files stored on the CardDrive according to an example embodiment.

FIG. 20 is a flow chart of an example method of attaching a file from a secure CardDrive to an email using a Mobility application in accordance with an example embodiment.

Like reference numerals refer to the same or similar components throughout the several views of the drawings.

### DETAILED DESCRIPTION

Described herein are devices and methods for secure portable data storage and file transfer. In the following description, for purposes of explanation, numerous examples and specific details are set forth in order to provide a thorough understanding of the present invention. It will be evident, however, to one skilled in the art that the present invention may include some or all of the features in these examples alone or in combination with other features described below, and may further include modifications and equivalents of the features and concepts described herein.

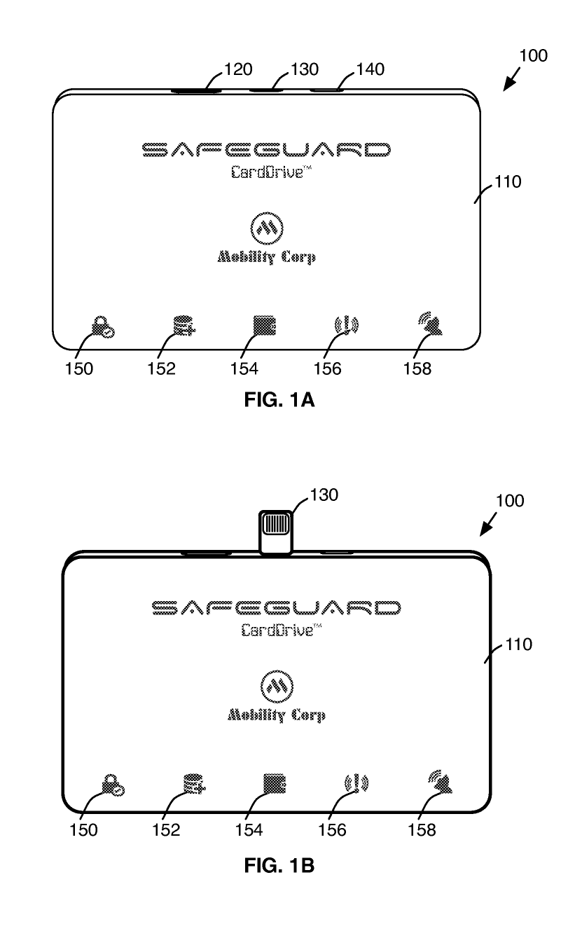

Referring to FIGS. 1A and 1B, an example embodiment of a CardDrive device 100 includes a case 110 (which may also be referred to herein as a “body” or “housing”) dimensioned to approximate a credit card or other card that may easily fit into a user's wallet, pocket or purse. One or more connectors 120, 130, 140 may be integrated within case 110, e.g., for communication with different types of mobile phones, tablets, laptop computers, or other computing devices. Each connector 120, 130, 140 may be selectively deployable from the case, e.g., by a slide mechanism or hinge mechanism that allows the desired connector to extend from the body 110 such that connector may engage with the port of a corresponding device. For example, connector 120 may be a USB connector for connecting to a computer or other device, e.g., directly into a corresponding port on the computer or via a coupling cable. Other connectors or ports may be used, e.g., any desired combination of a USB, mini USB, micro USB, Lightning connector, HDMI, mini HDMI, micro HDMI, audio jack or connector, power jack or connector, other desired ports or connectors depending upon the desired types of devices to be connected.

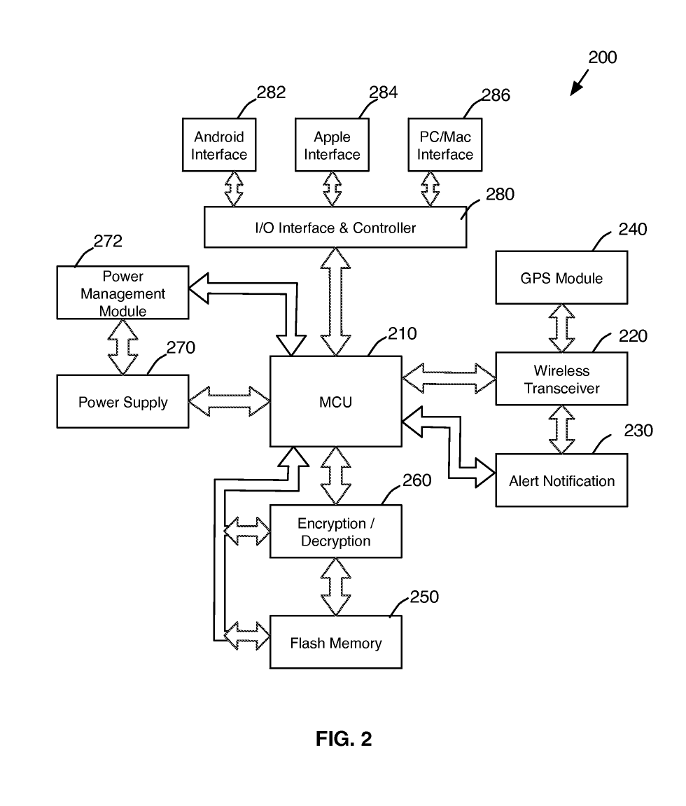

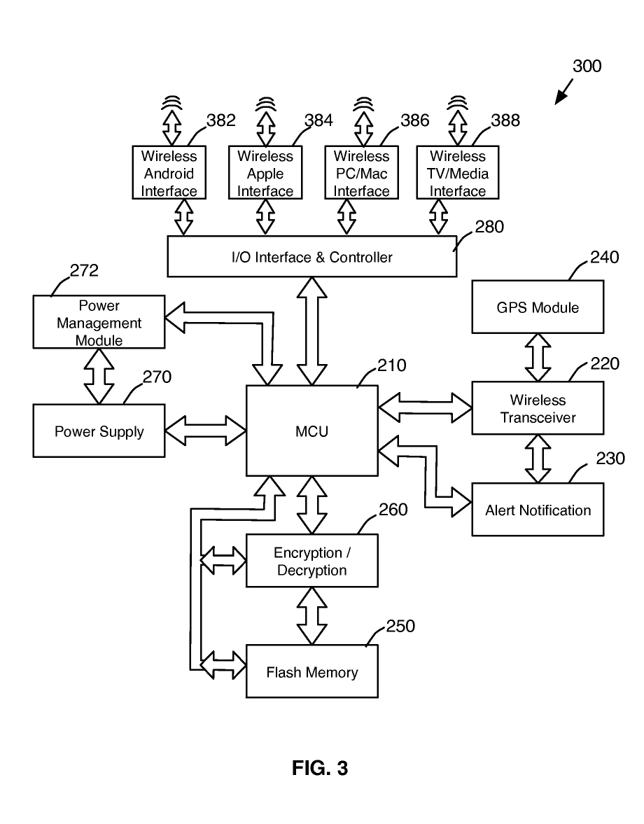

In some embodiments, case 110 may dimensioned substantially as a rectangular prism, with planar walls defining an interior space for housing electronic components of the device, such as a controller, memory, interfaces, and other components described below with respect to FIGS. 2 and 3. Case 110 may have a front face and rear face each having a length and a height substantially approximating the dimensions of a credit card, for example a length of approximately 85 mm (or 80 mm to 90 mm), a height of approximately 54 mm (or 49 mm to 60 mm). Each corner of the faces may be substantially rounded, e.g., with a radius of 2.88-3.48 mm (or 1 mm to 4 mm) in some embodiments. Case 110 may have a thickness of approximately 3 mm (or 1 mm to 4 mm). In some embodiments, at least the length and height of a CardDrive may substantially conform the international ID-1 standard under ISO/IEC 7810 for credit card sizes. In other embodiments, one or more dimensions conform to ISO/IEC 7810 ID-1, ID-2 or ID-3 standards for identification card sizes. Other shapes, configurations and dimensions of case 110 may be used without departing from the scope of the invention. Case 110 may be constructed of any desired material or combination of materials, for example aluminum (which may be anodized), plastic, steel, other metals or alloys, ceramic, or other composite materials as desired. Case 110 or portions of case 110 may be opaque, translucent or transparent, as desired.

In some embodiments, a CardDrive device may include two or more connectors as shown in FIG. 1A, such as any combination of a USB connector 120 (e.g., for connection to a laptop computer or other computer device or accessory), a Lightning connector 130 (e.g., for connection to an Apple iPhone or iPad), and a micro USB connector 140 (e.g., for connection to a Samsung Galaxy or other Android phone or tablet), and/or other desired connector or port. In some embodiments, one or more of the connectors are integrated with the device, such that each may be stowed within the device and selectively deployed for use, e.g., using a hinge or slider mechanism to selectively deploy or stow each connector 120, 130, 140.

In some embodiments, a CardDrive device 100 may include indicia indicating one or more features of the device, such as data encryption and security 150, high-capacity storage 152, file management 154, wireless communication and real-time alerts 156, and GPS location services.

Turning now to FIG. 2, an example embodiment of a CardDrive device 200 includes a microcontroller 210 for controlling processes within the device 200, a flash memory 250 for storage of files and other data, a power supply 270 for providing power, an input/output interface and controller 280 for enabling and controlling communications with external devices, and a wireless transceiver 220 for sending and receiving wireless signals. Device 200 may also include an encryption/decryption module 260 for securely storing files, a power management module 272 for managing power. An alert notification module 230 and a GPS module 240 may communicate via wireless transceiver 220, e.g. to provide real time tracking of the device (e.g., if it is lost or stolen and/or for incorporating location information into file storage or transfer logs) and/or to provide real time alert notifications. Such alert notification may include, for example, an email, text message, or other alert, notification or signal sent to a user (e.g., using an associated mobile application) to communicate an attempt to access data or files on a device, a completed file transfer, detection of an associated CardDrive device or authorized user within wireless range. Various other desired alerts or notifications may be configured, and automated or selective responses or actions such as blocking further access may be configured. In some embodiments, automatic synchronized mirror backup routine may be used to automatically backup all of the data stored on one card to another card, e.g., for extra security or to share files in a private network when the two cards are connected or in wireless rang.

Encryption/Decryption Module 260 works with MCU 210 to provide encryption and decryption of files transferred to and from a CardDrive (e.g., card drive 200 or 300 of FIGS. 2 and 3). Module 2060 may include instructions for encrypting files for storage in flash memory 250 and/or decrypting files retrieved from flash memory 250, as directed by MCU 210. In some embodiments, Encryption/Decryption 260 may employ a symmetric key algorithm such as that described by the Advanced Encryption Standard, or AES (Federal Information Processing Standards Publication 197. United States National Institute of Standards and Technology (MIST). Nov. 26, 2001), which is incorporated by reference herein in its entirety. In preferred embodiments, CardDrive 200 does not rely upon any external computing device for control of encryption or decryption, as MCU 210 may provide instructions for operation and control of all modules and features of the device 200.

I/O interface and controller 280 may communicate with MCU 210, and be configured to transmit signals to and from a number of interfaces 282, 284, 286, each adapted for wired or wireless communication with a different type of device (e.g., a particular type or brand mobile telephone/smart phone, a tablet computer, a laptop computer, a desktop computer, a television, a speaker, or a camera, media device, storage device, peripheral device, etc.). For example, interface 282 may be an android interface, for providing communications to and from an android device (e.g., via a micro USB connector), interface 284 may be adapted for communications with an apple device (e.g., via an Apple lightning connector), and interface 286 may be adapted for communication with a computer (e.g., via a USB connector). Such communications may be controlled by the MCU 210 and/or I/O Interface and controller 280, and may provide for secure communication to specific authorized devices.

Wireless transceiver 220 may be configured to communicate via a local network or via the Internet, e.g., through a WiFi or cellular network connection. Other communication protocols and/or networks may be used as desired, depending upon the application and types of information to be transmitted. Additional optional communication protocols are described below with respect to FIG. 3. Wireless transceiver 220 may communicate with GPS module 240 (e.g., to send or receive messages relating to a position of the drive 200) and/or with alert notification module 230 (e.g., to send status alerts or messages to a user via email, text message, or though an associated application in the user's mobile device). Power supply 270 may be a battery or other wired or wireless power supply sufficient for proving power to the system 200. Power management module 272 may communicate with MCU and power supply, e.g., to manage power usage of the system 200. Such parameters may be controlled by the MCU and/or power management module 272, and be preconfigured and/or configured by a user (e.g., via a mobile application running on a mobile device associated with CardDrive 200).

Referring to FIG. 3 another embodiment of a CardDrive 300 may include many of the same features as device 200, except including features for short-range wireless communication with mobile devices, computers, televisions and other desired devices. For example, device 300 may include wireless interfaces for communicating with Android 382 Apple iPhones or iPads 384, personal computers (including laptops or desktop computers of any kind) 386, and television or other media devices 388.

In some embodiments, one or more of the wireless interfaces 382, 384, 386, 388 is configured for short range wireless communication protocols such as Bluetooth, infrared, Zigbee, or WiFi. In some embodiments, a CardDrive 300 is configured to wirelessly communicate with, and automatically or selectively transfer files to and from, a computer or mobile device, for example when the CardDrive 300 and a mobile device are in a desired proximity or wireless range. In some embodiments, multiple CardDrive devices may be configured to communicate with each other when they are in wireless communication range, e.g. to share files or other data between designated devices. Each CardDrive 300 may be configured with settings and/or user permission levels to configure access and security settings for each user or mobile device, to designate files or data to be shared (if any), and to configure other features of the device as desired. In some embodiments, such configuration may be performed using a software application on a mobile device connected to or otherwise in communication with the CardDrive 300. In some embodiments, wireless transceiver 220 of CardDrive 200 or 300 may perform the function of one or more wireless interfaces 382, 385, 386, 388, e.g., to provide local, secure wireless communications with selected mobile devices.

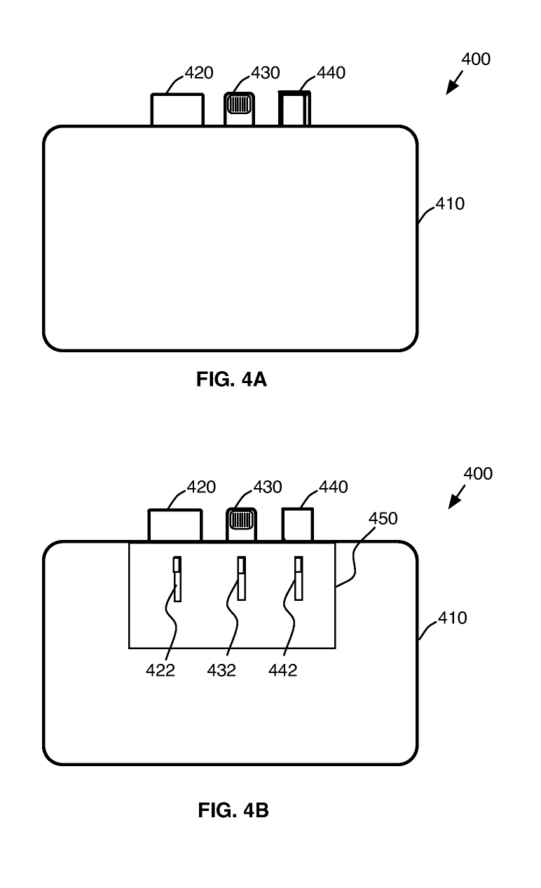

Turning back to device FIGS. 4A, 4B, 4C and 4D, an example embodiment of a CardDrive 400 is shown, and may include features described above with respect to CardDrives 100, 200 and 300, including a body 410 and a number of connectors 420, 430, 440. In this example, connectors 420, 430, and 440 may be similar to USB connector 120, Lightning connector 130 and micro USB/Android connector 140 of FIG. 1. Connectors 420, 430 and 440 are shown as selectively deployable, e.g., by activating a slide member 422, 432, or 442 to eject the desired connector. For example, to connect CardDrive 400 to the Lightning cable port of an iPhone or iPad or other Apple device, a user may deploy or eject Lightning connector 430 by sliding upward on the corresponding slide member 432, while slide members 422 and 442 may be left in the down, or stowed position. In such configuration, connector 430 may extend from an edge of the CardDrive 400, for example as shown by connector 130 extending from body 110 of card 100 of FIG. 1B. In some embodiments, connectors 420, 430, 440 or other connectors may be hingably connected to body 410, such that each connector may be selectively rotated into a deployed position or a stowed position as desired. In other embodiments, one or more ports may also be included instead of or in addition to the above-described connectors. Such ports may include, for example, ports for providing power to the device and or ports for connecting a communications cable to access data, provided updates, and/or configure the device 400.

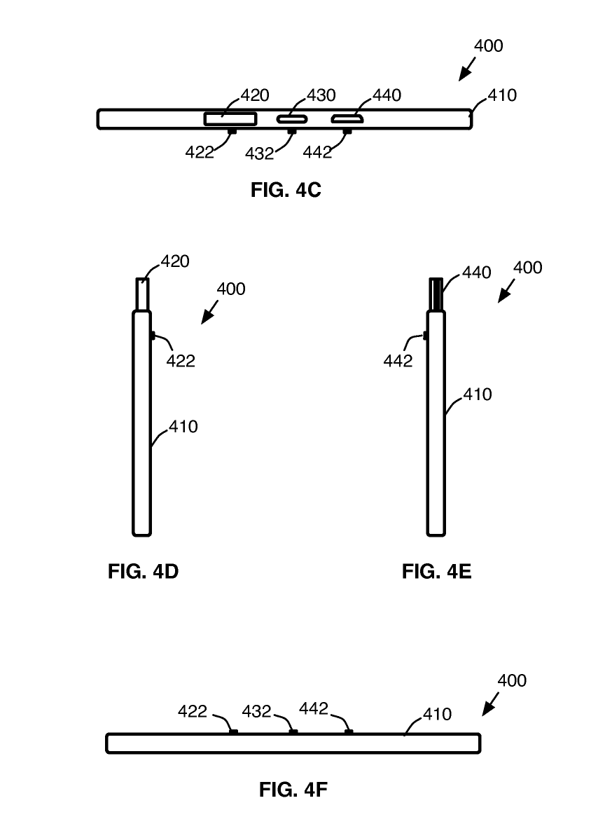

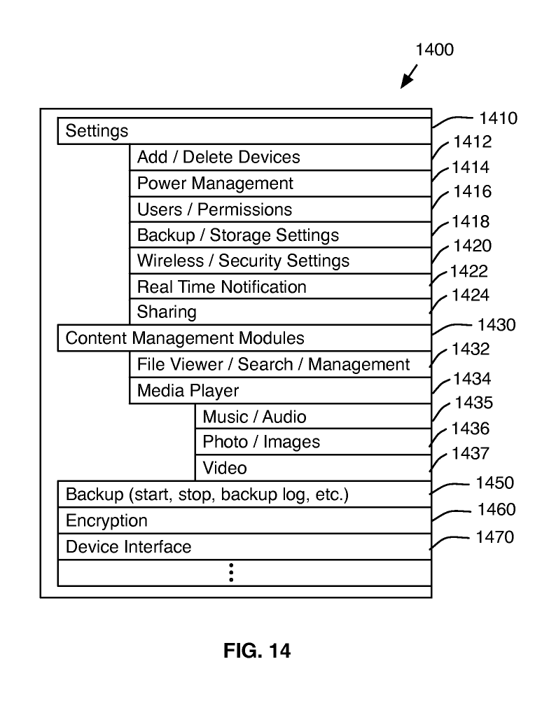

Referring to FIGS. 5A and 5B, methods 500-1 and 500-2 of communicating between a mobile phone 510 or tablet 520 (or other mobile device) and a CardDrive 400 are shown. To connect CardDrive 400 with a mobile device (510, 520), the connector corresponding to the desired mobile device is deployed from the body of the CardDrive 400 as described above. In the example sown in FIG. 5, an Apple/Lightning connector 430 may be deployed and inserted in the corresponding port of an iPhone device. For an Android phone or other mobile device, the desired connector 420, 430, 440 may be deployed and other connectors may be stowed. Once connected, a software application on the mobile device 510, 610 may be launched to control transfer of files between card 400 and device 510, 610. Such application may include features for configuring access and communication settings; browsing, copying, transferring, deleting or otherwise managing content stored within memory 250 of the card 400; viewing or playing media content stored on the card 400 (e.g., using a media player within the application to play music, view photos, or play movies); and features to control backups, view logs, interface with other mobile devices, cards, media devices, or storage devices. In some embodiments, a mobile application in the device 510, 610, includes features for controlling, transmitting and paying audio and video content to an external monitor or television (e.g., via an HDMI interface), speaker, and/or other desired display device. Examples of modules that may be employed in a mobile application are shown in FIG. 14. In some embodiments, a connected CardDrive may be accessible, e.g., appearing as an external drive, using any file manager application installed in the device (for example, on an Android phone or tablet).

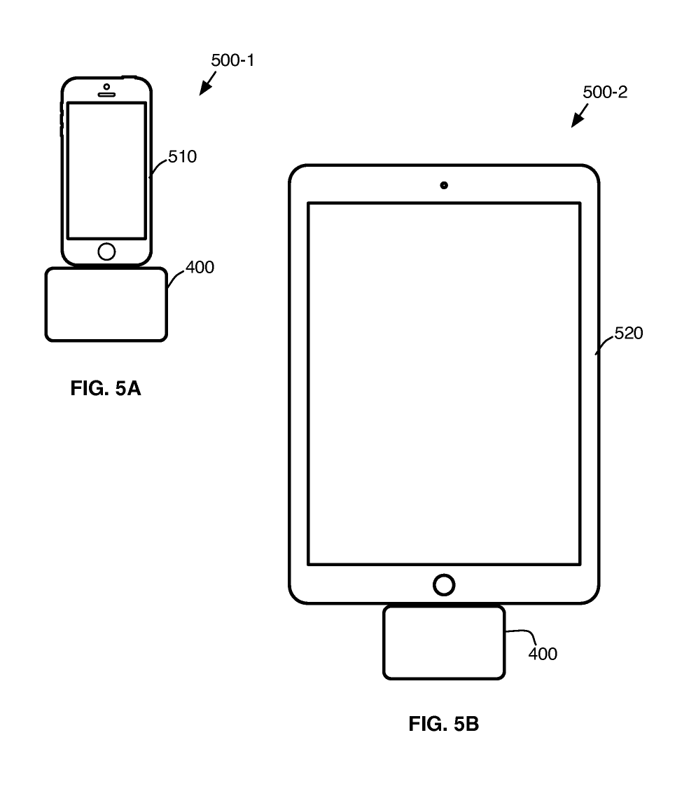

Turning now to FIGS. 6A and 6B, a wireless CardDrive device 600 is illustrated according to an example embodiment. CardDrive 600 may include a case or housing 610, and the housing may enclose a MCU 210, wireless transceiver 220, flash memory 250, encryption/decryption module 260, I/O Interface 280, wireless interfaces 382, 384, 386, and/or 388, GPS Module 240, and/or other features and modules as described above with respect to example wireless system 300 of FIG. 3. A power port 620 may be configured to receive a power plug or other connector to supply power to the device. In some embodiments, housing 610 may be configured and dimensioned to approximate the size and form of a credit card, for example approximately 85.60 mm long×53.98 mm high (3.37 in×2.125 in), e.g., conforming to the international ID-1 standard under ISO/IEC 7810 for credit card sizes. In some embodiments, the housing 610 may have a thickness of 3 mm, or between 1 mm to 4 mm, as may be necessary accommodate an MCU 210 chip, memory 250, and other components within housing 610. Other sizes or configurations of housing 610 may be used without departing from the scope of the invention.

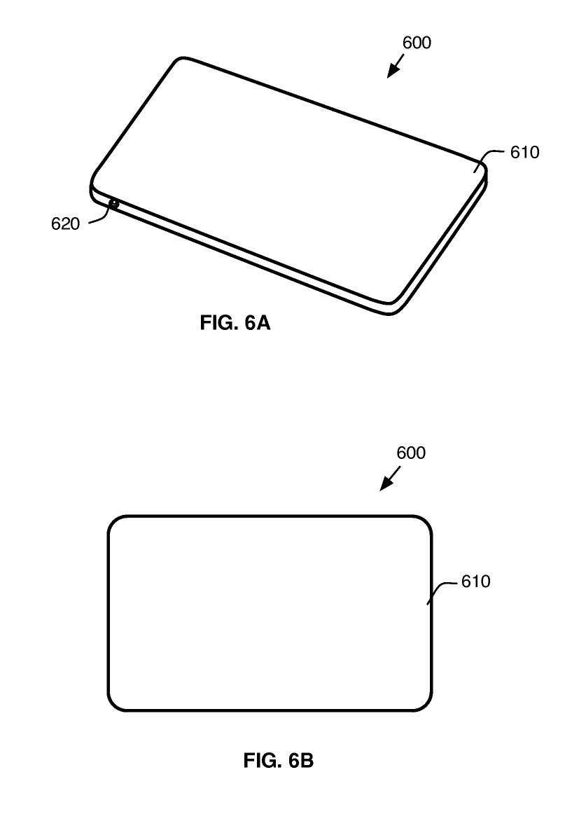

FIGS. 7A and 7B show another example embodiment of a CardDrive device 700. Like device 600, device 700 may include a case or housing 710, e.g., to enclose a MCU 210, wireless transceiver 220, flash memory 250, encryption/decryption module 260, I/O Interface 280, wireless interfaces 382, 384, 386, and/or 388, GPS Module 240, and/or other features and modules as described above. Device 700 may also include a port 720, e.g., configured and dimensioned to receive a connector to provide power and/or communicate with the device 700. In some embodiments, port 720 is a micro USB port. In other embodiments, one or more ports of any desired type or size 720 may be incorporated (e.g., micro USB, mini USB, Lightning cable, HDMI, audio jack, or other desired type of connector port.). In some embodiments, device 700 may include ports or interfaces for communicating with or receiving an external memory card (e.g., an SD Card or other removable memory card or stick), or a camera, a printer or other peripheral device).

In some embodiments, device 700 may include one or more indicators 730, 732, for example lights to indicate a state or activity of the device. For example, a desired combination of light color and/or frequency (e.g., solid, slow blink, fast blink) may be used to indicate device power or charge status, connection status, data transfer, etc.). In some embodiments, one or more 730, 732 may be a button, switch or device for user input, for example to turn device 700 on or off, or to initiate, cancel or pause a desired activity, or to set a mode for the device 700 (e.g., wireless connection or pairing mode, or auto/manual backup mode).

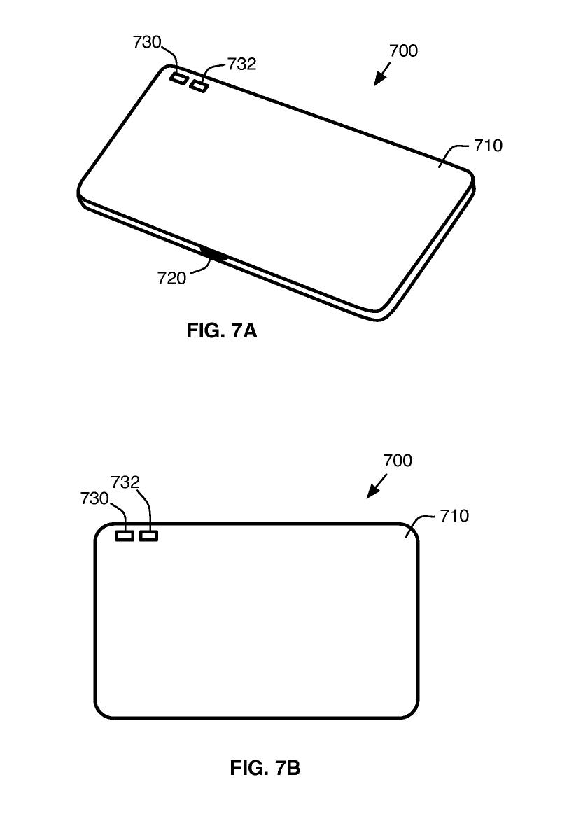

Referring to FIG. 8 a wireless CardDrive device 700 of FIGS. 7A and 7B is shown in communication with other devices according to an example embodiment. For example, CardDrive 700 may communicate with any desired number of devices, such as one or more smart phones 510, tablets 610, computers 810, 812, or televisions, monitors or other media devices 814. Device 700 may communicate wirelessly using wireless transceiver 220 and/or any one or more wireless interfaces (e.g., a wireless Android interface 382, a wireless Apple interface 384, wireless PC/Mac interface, or a wireless television/media interface. In some embodiments, wireless communications between CardDrive 700 and other devices 510, 610, 810, 812, and 814 employ short range wireless communication protocols such as Bluetooth, infrared, Zigbee, WiFi, or other wireless communication protocols. In other embodiments, WiFi or other wired or wireless communication methods may be used. Communication between CardDrive 700 and other mobile devices, e.g., to synchronize stored files, may be initiated manually or automatically, for example when the MCU in the card senses a connected or authorized device within range of the CardDrive 700.

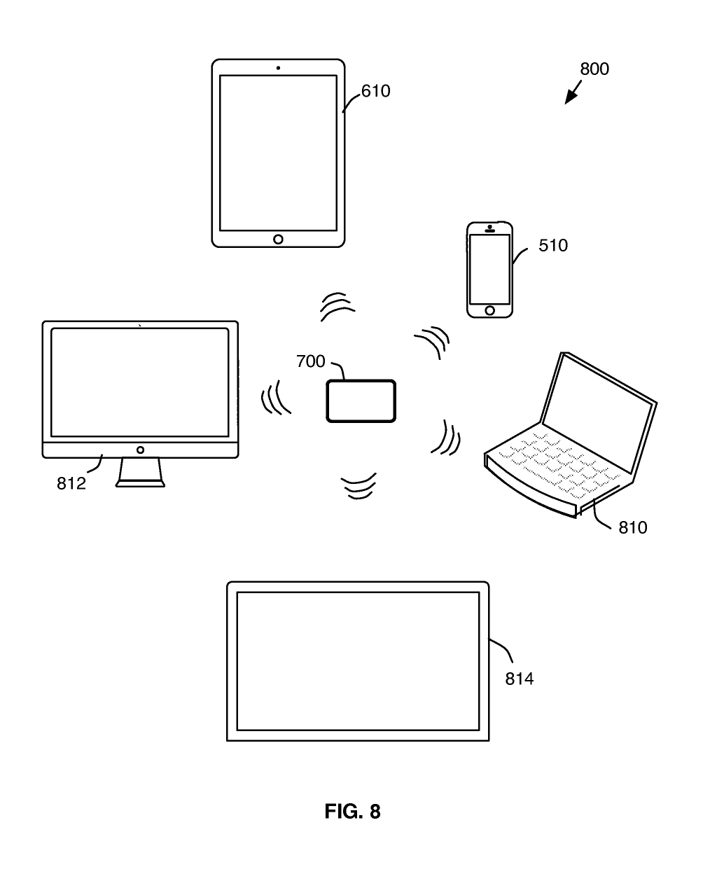

In some embodiments, a network 900 of multiple CardDrives 700-1, 700-2, 700-3 may be used. For example, cards 700-1, 700-2, and/or 700-3 may be configured to detect and/or wirelessly connect or communicate with one or more authorized CardDrives within wireless range. In such embodiments, files may be transferred or shared among a private network of cards 700-1, 700-2, 700-3, such that devices authorized to connect to each CardDrive may be able to share files (e.g., documents, data, photo, music, and/or video) within the private network. In some embodiments, a CardDrive or network of wirelessly connected CardDrives can also allow direct mobile phone to mobile phone encrypted and secured communication (voice/text/email) via a private CardDrive network 900 as illustrated in FIG. 9.

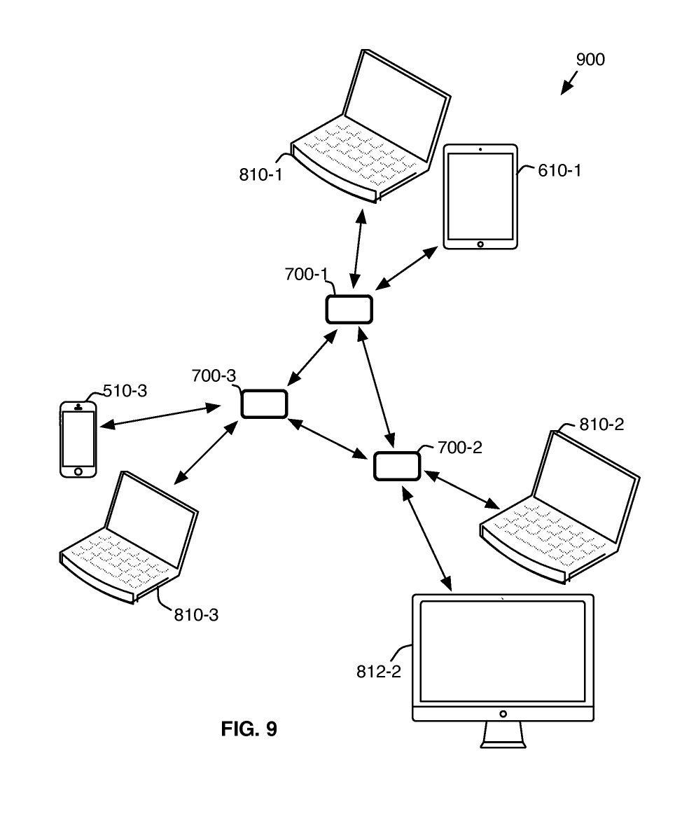

Referring to FIGS. 10A and 10B a cradle 1000 for a CardDrive device according to an example embodiment is shown. Cradle 1000 may include a body or base 1010 within which is a slot or stand 1020 capable of receiving and/or supporting a CardDrive (e.g., drive 700 or 600). Within slot 1020 may be a connector 1022, e.g., a micro USB or other connector corresponding to a port (such as port 720 of FIG. 7A or 620 of FIG. 6A) to provide power and/or other signals or data communication with the CardDrive. Cradle 1000 may also include a power and/or data cord 1040 leading to connector 1022, and/or one or more lights or buttons 1030. In some embodiments, light 1030 may be used to indicate charge status of a CardDrive device inserted into the cradle slot 1020 (e.g., using desired colors, intensity, and/or flashing patters of the light 1030). In other embodiments, 1030 may be a button or other feature to provide input to the cradle 1000 and/or a connected CardDrive.

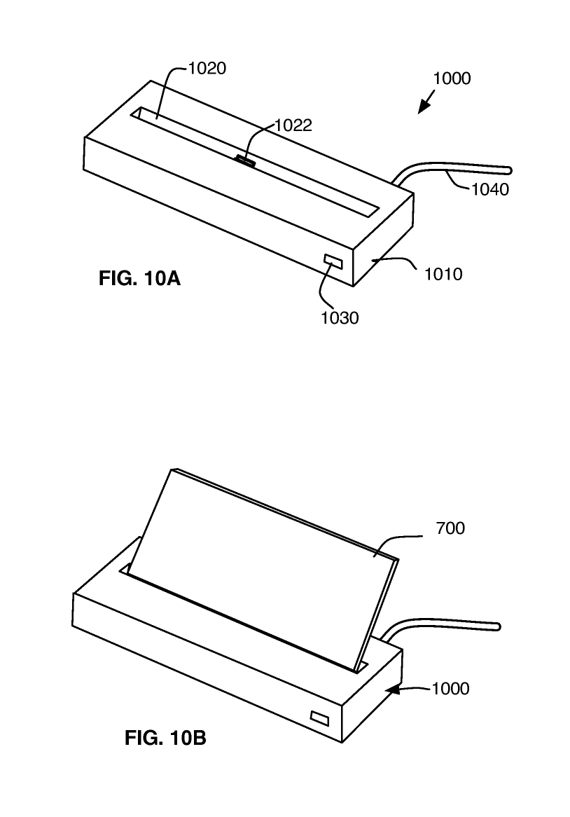

Referring to FIGS. 11A, 11B and 11C another example embodiment of a CardDrive device 1100 is shown. Drive 1100 may have similar features to drives 100, 400, 600, and 700 described above, including a housing 1110 for housing MCU 210, memory 250, and other components and modules described above with respect to FIGS. 2 and 3. Port 1120 of FIG. 11B may be a power and/or data port, and may be configured to engage with a micro USB connector or any other desired type of port or connector, as described above with respect to port 720 of FIG. 7A. One or more lights 1130, 1132 or other indicators or buttons may be integrated within case 1110. For example, any combination of light colors, intensity and/or frequency may be used to convey status information (such as charge level or device activity). In some embodiments 1130 and/or 1132 are buttons (optionally lighted buttons) that may be used alone or in combination to provide input to the device 1100 (such as on/off, start, stop, pause, connect, disconnect, reset or reboot, etc.). In some embodiments, one or more additional connectors or ports 1140 may be incorporated, e.g., on a side of the housing 1110 as shown in FIG. 11C. In this example, 1140 may be an HDMI port, for example to receive an HDMI cable for transmitting audio and/or video signals from the drive 1110 to a display monitor, television, and/or speakers. For example, a mobile device connected with drive 1100 (wirelessly or by a cable coupled with port 1120) may include an application adapted to access and play a music, video or other media file from the drive 1100, and the media signal(s) may be transmitted via port 1140 to a television. In other embodiments, audio and/or video signals are transmitted wirelessly (via Bluetooth, WiFi, infrared, Zigbee, cellular network, or other desired protocol or network) to a television or other display device or a receiver coupled to such device.

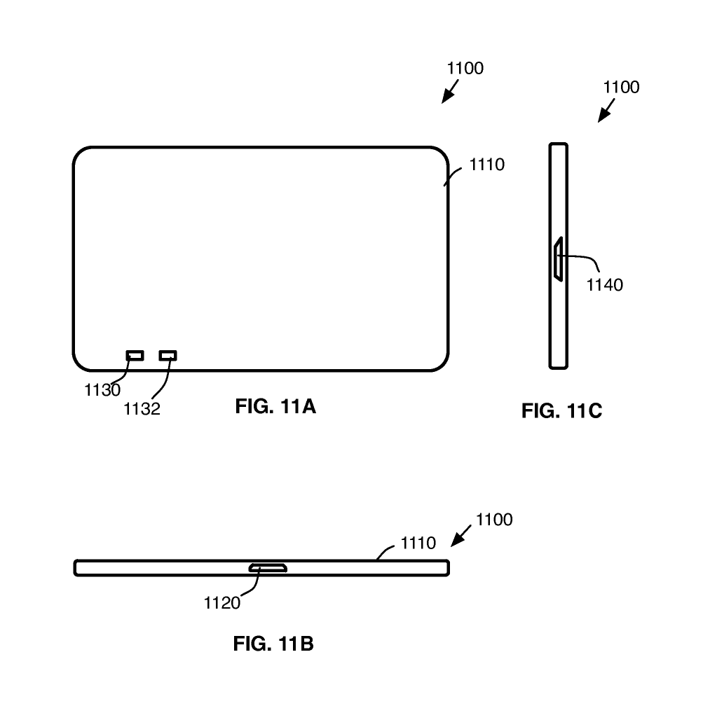

Turning now to FIG. 12, an example embodiment of a flash drive storage device 1200 is shown. In this example, device 1200 may include a body or housing 1210 and two or more connector, for example a USB connector 1230 and a Lightning connector 1220. Different types of connectors may allow for connection to different types of mobile devices and/or computers. Although example device 1200 is shown to have a different form factor than other embodiments described herein (most of which are generally configured and dimensioned to approximate the size of a credit card), device 1200 may include many of the same internal features and modules as described above with respect to FIG. 2 and FIG. 3, including a MCU 210, wireless transceiver 220, flash memory 250, encryption/decryption module 260, alert notification 230, and/or other features and modules as described above.

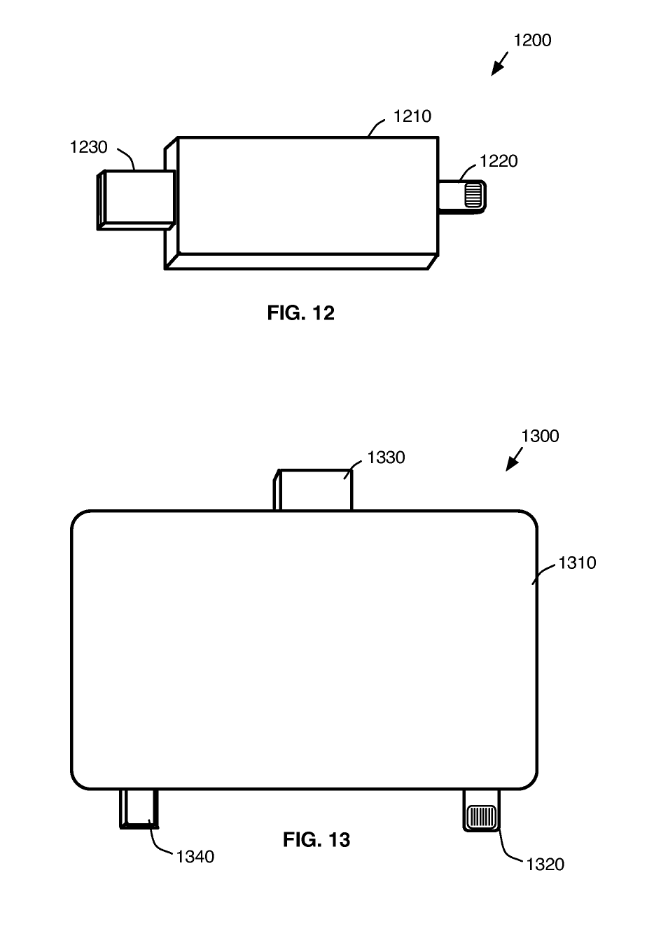

Referring to FIG. 13 another example embodiment of a CardDrive device 1300 is shown, including a body 1310 and a plurality of connectors 1320, 1330, and 1340. In this example, similar to devices 100 and 400 described above, any combination of connectors may be included, such as a Lightning connector 1320, a USB connector 1330, and a micro USB (or Android) connector 1340. Each connector 1320, 1330, 1340 may be retractable and/or selectively deployable as described above with respect to FIG. 4, and housing 1310 of device 1300 may include any desired features of other drives described above (including functional modules and other features of FIGS. 2 and 3).

Turning now to FIG. 14, a schematic representation of an example mobile application 1400 (sometimes referred to herein as “Mobility App”) may include a number of functional modules for configuring and communicating with a CardDrive device. Such an application may be run on a mobile phone, tablet, or other device, and may include modules or features for configuring settings 1410 of a particular CardDrive connected to or associated with the mobile device. Examples of configuration settings may include settings for adding and deleting devices 1412, power management 1414, setting authorized users and permission levels 1416, configuring backup, sync or other storage settings 1418, configuring wireless networks and/or security settings 1420, real time notification 1422, and sharing 1424.

For example, add/delete devices 1412 may present input fields and/or parameters to a user to associate one or more CardDrives with one or more mobile devices, computers or other CardDrives. Power management 1414 may be used to configure power settings for the device, e.g., to configure operation/sleep times or parameters for a CardDrive. Configuring users and permissions 1416 allows for control of access to information on a CardDrive, e.g., limited to authorized users with proper passwords, and permission levels or limits may be set for each user (e.g., to access certain files and/or perform certain functions such as read/write/delete). Backup/storage settings 1418 may be used to configure preferences for frequency and other parameters related to backup or file sync between a CardDrive and a corresponding user's computer. Wireless/security settings 1420 may be used to configure connections with wireless networks and to set security parameters as desired. Real time notification 1422 may be used to set parameters for detecting and notifying unauthorized access or attempts to access information on a CardDrive. Configuration of sharing 1424 allows a user to configure an associated CardDrive to communicate in a private network with other CardDrives connected to or within wireless range of the user's drive.

Content management modules 1430 allow for access and management of files and data stored on the associated CardDrive. For example, a file viewer/search/management module allows a user, through an application 1400 in a mobile device, to locate, view and manage files stored in an associated CardDrive. Module 1430 may also include a media player 1434, such that a user may select media files (e.g., video 1437, audio 1435 and/or photos 1463) from an associated CardDrive and play or display the content on a connected (wired or wirelessly) television, monitor, or other output device. Other modules may include a backup module 1450, e.g., for controlling on-demand backup of files and/or view reporting logs or other feature of file backup/sync. An encryption module 1460, may be incorporated to help configure and direct encryption files and data stored on a mobile device. A device interface module may also be included, e.g., to provide steps and information for interfacing with different types of devices. Examples of using a mobile application to configure and control operation of a CardDrive are shown and described below.

In some embodiments, a Mobility App may be used to securely connect wirelessly to any media device with HDMI interface such as TV, to playback and display any movies, presentations, music videos or songs or any documents. In some embodiments, utilizing free Mobility Apps allow a CardDrive to work with any of the above devices and also function as a music player and movie player. All functions and control are accessible via the user cell phone or tablet utilizing the Mobility loaded App.

### METHOD EXAMPLES

The following are examples of use of a CardDrive apparatus according to some embodiments of the invention. These examples are intended to be illustrative, and not exhaustive, of potential methods of use and representative features of devices described herein.

### Transferring Files

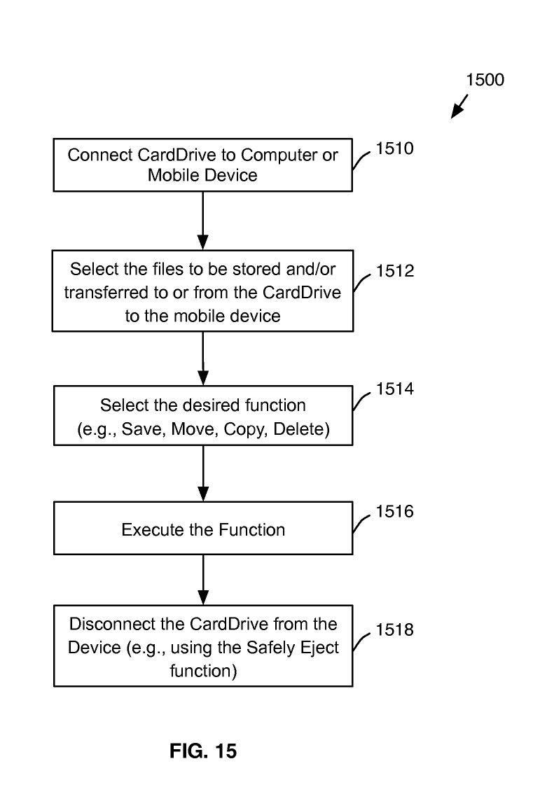

As shown in FIG. 15 a method 1500 of using an application (sometimes referred to herein as a “Mobility App”) to transfer files between a mobile device and a CardDrive having selectively deployable (also referred to herein as “ejectable”) connectors (e.g., drive 100 or 400) may begin with connecting 1510 the CardDrive to any of the above mobile devices and or computer using any of the appropriate connectors (e.g., a USB to plug to any laptop or computer, a Lightning connector to connect to any Apple mobile device such as tablet or iPhone, a Micro USB ejectable connector to connect to any Android mobile device or other devices with Micro USB connectors. Next, select 1412 the files to be stored and or transferred to or from the CardDrive to the mobile device. Then select 1414 the required function, such as Save as, Move, Copy, Delete, etc., and the selected function is executed 1416. Once the function is complete a user may disconnect the CardDrive from the device, for example, using a “safely eject” function built into the mobile application or another application. In some embodiments, a CardDrive and/or a mobile application running on a mobile device associated with the CardDrive, is configured to automatically detect changes in files (e.g., new files, or changes to files), and to automatically back up copies of the new or changed files to the CardDrive.

In some embodiments, for the CardDrive with fully wireless communication and no ejectable connectors, all above functions may be the same except the selected device will be selected and accessed wirelessly without any need to physically connect or disconnect the CardDrive from any of the above mobile devices or computers. Access to any HDMI devices may be done similarly.

In some embodiments, access to any files on the CardDrive is logged inside the CardDrive in an internal Login Register File that logs in the date and time and which file has been accessed and what function took place, such as Copy, Save, Delete, move etc.

In some embodiments, in a CardDrive with no ejectable connectors and only full wireless interfaces a user may select from two or more modes of operation: e.g., Manual and Auto modes. In and example Manual Mode each and every time a file is accessed, copied, saved, edited, or deleted, it must be first approved by the user, e.g., by selecting and pressing either the “YES” button to approve the function to be performed or “NO” to disable the function or operation. YES or NO buttons may appear, for example, in a pop up menu following the request to access, copy, save or move any file. In the Auto Mode every function and operation or access to any file may be allowed based on the preselected settings set by the user in the user setting control menu. In some embodiments, DELETE or EDIT Functions are only available in Manual Mode. In some embodiments, these functions may not be available in Auto Mode for security reasons.

### Automatic Wireless Backup/Sync

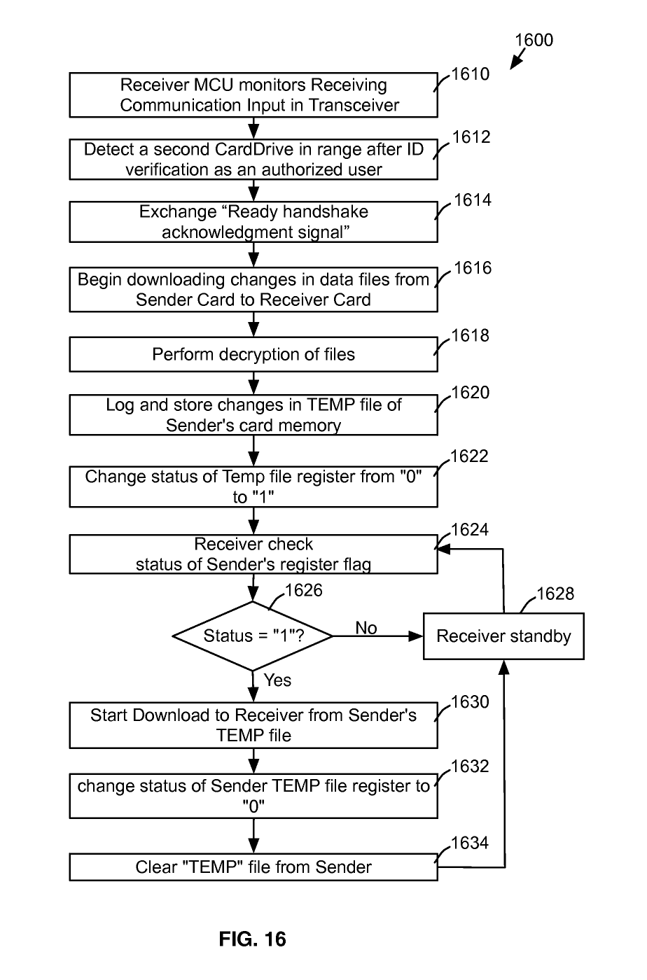

FIG. 16 shows an example method 1600 of performing an automatic wireless backup or “sync” between two CardDrives in a private network (e.g., as shown in FIG. 9), with reference to CardDrive modules from FIG. 2. In this example MCU 210 in “Receiver's Card” continuously monitors 1610 “Receiving Communication Input” in transceiver 220 of same card (in loop) to see if there is an “handshake ACK (acknowledgment) signal” received from the “sender's Card”. This means cards are in operating range and can communicate with each other.

In 1612, a second CardDrive is detected in range and ID verified as an authorized user. The two drives then exchange 1614 “Ready handshake acknowledgment signal” to start transfer of any recent changes of the sender CardDrive memory (between the “sender's Transceiver 220” and the “receiver's Transceiver 220”). Each CardDrive can be selected as “Receiver” or “Sender” from the settings menu (e.g., in a user's Mobility App) or changed at any time by the owner/user of the respective CardDrive.

In 1616, sender's CardDrive starts downloading any changes in data files from “sender's Card-Transceiver 220” to “Receiver's card-Transceiver 220”. Start performing decryption 1618 of files and data in accordance with the procedure and methods described in the “Encryption/Decryption Algorithm” by Encryption/Decryption module 260 of FIG. 2.

All changes in “Sender's Card” memory are logged and stored 1620 in a temporary file called “TEMP” (located inside 250 Flash Memory, separate location from main memory) in addition to being stored in the main memory 250. Once a change occurred the TEMP file changes the status of its file register flag from “0” logic to “1” logic 1622 to indicate a change has occurred.

Upon completion of the initial handshake and ID verification the Receiver's Card is checking 1624 the status of the sender's register flag status to see if it is “1” logic 1626. If “1” logic then the download starts 1630. If “0” logic then receiver's card stay on standby 1628, and keep monitoring the status of the TEMP register flag periodically 1624 (loop time periods can be adjusted in settings menu).

Once the transfer of data changes is complete, via transceivers 220 the “TEMP” register flag will reset back to “0” logic 1632, to wait for the next set of changes to occur. The “TEMP” file then will be cleared of all data 1634, ready for next changes to be stored into it. Once any changes occur the “TEMP” register flag will be set to “1” logic again.

### Alert Notification

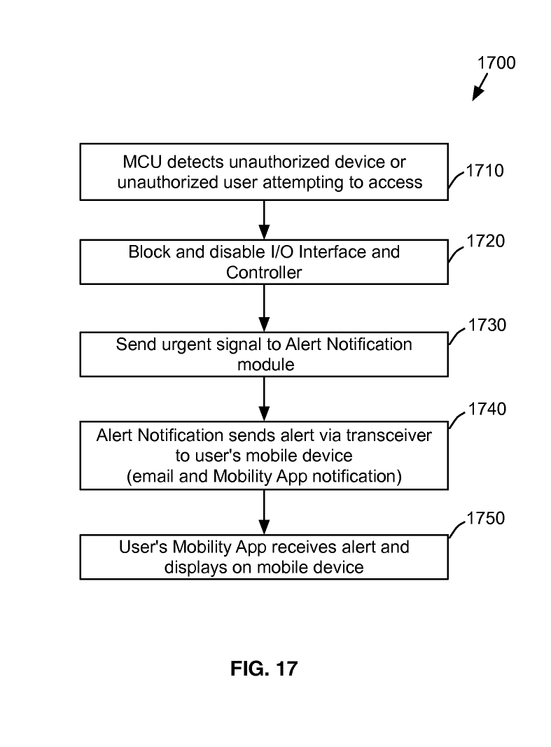

Turning now to FIG. 17, an example of an alert notification method 1700 is shown, using the Alert Notification 230 module of FIG. 2.

As an initial step 1710, the MCU 210 of a CardDrive detects an unauthorized device connected to the CardDrive and or unauthorized user is attempting to access the CardDrive device.

In 1720, MCU 210 automatically blocks all communication to and from all ports and interfaces, 282/382, 284/384, 286/386 and 388, e.g., by blocking and disabling the I/O Interface and Controller 280. Simultaneously, MCU sends an urgent signal 1730 to the Alert Notification module 230, which in turns sends a special alert 1740 via transceiver 220 to the user's cell phone. The user's Mobility App will receive this alert and display it on the user cell phone 1750, and may also sound a strong audio alarm signal, for example such as that used by cell phones for “AMBER Alert”. A pre-prepared auto email Alert Notification may also be sent to the user's email with the date and time and details of the attempted breach. This alert will be sent automatically to all authorized user's devices in range, including for example mobile phone 510, tablet 610, television 814 and computer 812 as shown in FIG. 8.

### Communication Process Between CardDrive and an Authorized Mobile Device

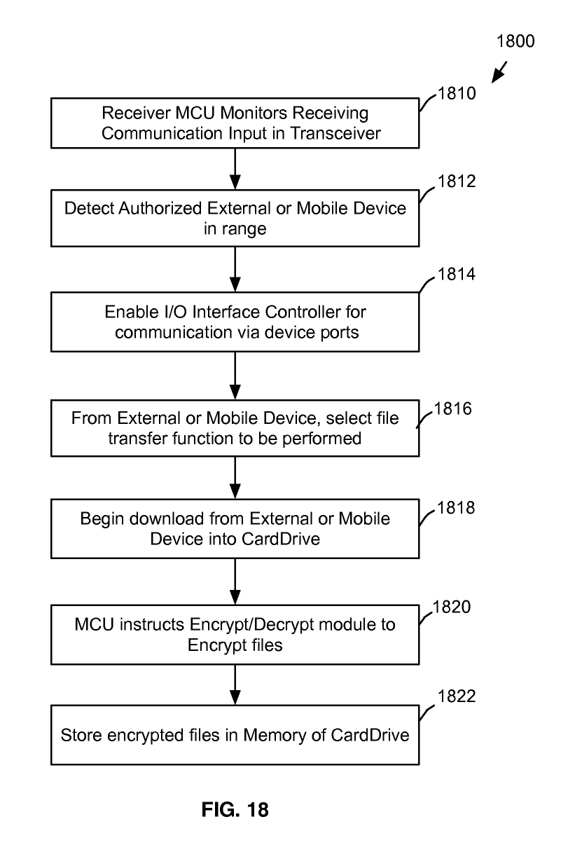

FIG. 18 is a flow chart depicting an example method 1800 of communicating between a CardDrive and an authorized mobile device, for example to transfer files. In this example, MCU 210 in CardDrive is continuously monitoring 1810 the “Receiving Communication Input” in transceiver 220 of same card (in loop) to see if there is a “handshake ACK (acknowledgment) signal” received from any authorized external and or mobile device (either via a wireless or via the hard wired connector type).

In step 1812, once MCU 210 has identified and determined that an authorized external device (e.g., an HDMI 814 type device and/or a computer 812 of FIG. 8) and/or a mobile device 510, 610 or 810, is physically connected or wirelessly communicating with the CardDrive, then it will enable 1814 (“open/on”) I/O Interface and Controller 280 for outside communication via ports 282/382, 284/384, 286/386 and 388. The normal state/mode of the I/O Interface and Controller 280 is disabled (“closed/off”) to prevent any unauthorized access to the CardDrive.

In step 1816, the user on the mobile and/or external authorized device selects a function (e.g., Move & Save, Move & Save as, Copy, etc.) and the file or files to be moved or copied.

In step 1818, start downloading from the external (HDMI 814 and or Computer 812, FIG. 8) and or mobile device 510, 610 or 810 into the CardDrive, and in 1820 the MCU instructs Encryption/Decryption 260 to performing encryption of the selected files.

Finally, in 1822 the selected files have been downloaded into the CardDrive as desired. All files are now encrypted and stored inside the CardDrive and can not be accessed by anyone other then the owner/user.

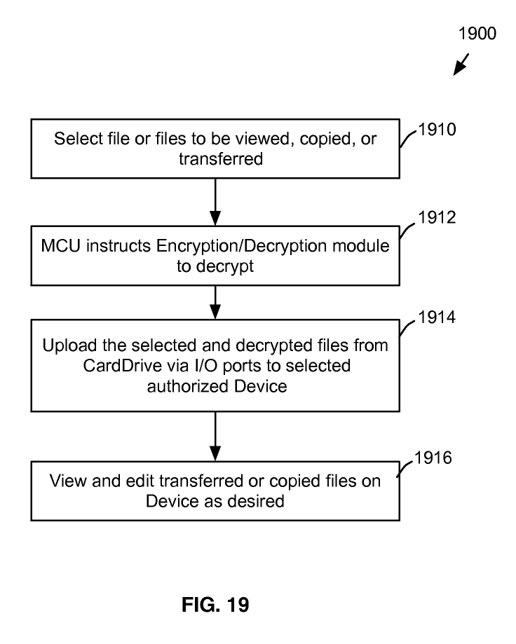

Referring now to FIG. 19, an example method 1900 for viewing or transferring files stored on the CardDrive may repeat the above process, except the direction of transfer is upload from the CardDrive to the external or mobile device.

In 1910, select the requested file or files to be viewed, copied or transferred.

In 1920, MCU 210 instructions Encryption/Decryption 260 to “decrypt” the selected files.

Then, the MCU uploads 1914 the selected and decrypted files from the CardDrive via ports 282/382, 284/384, 286/386 and 388 (see FIGS. 2 and 3) into the selected authorized device 510, 610, 810, 812 and or 814 (see FIG. 8).

Files have been transferred or copied from CardDrive to the external device and now available for viewing or editing as desired in 1916. In some embodiments, files that have been selected for viewing only are uploaded into a temp file but not stored on the external or mobile device. This temp file may be erased after the viewing or use of the file is complete, for example for security and/or privacy reasons.

### Attaching a File to an Email

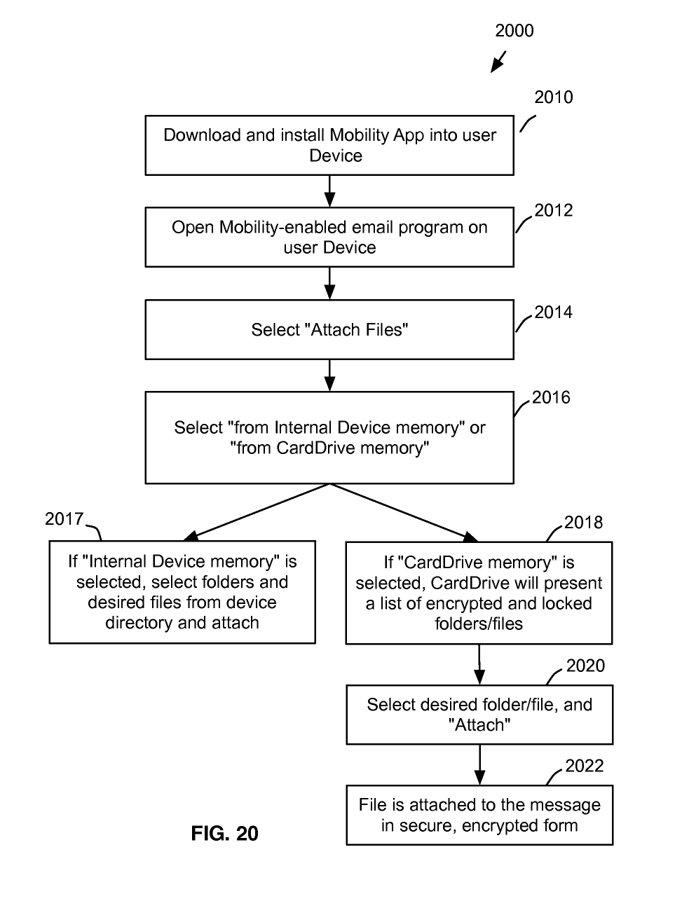

Referring to FIG. 20, an example method 2000 of using a software application for communicating with a CardDrive (e.g., a Mobility App) to attach a file from a CardDrive to an email on a mobile device, tablet or computer is shown. First, a Mobility App is downloaded and installed 2010 into a user device (e.g., a mobile device 510, tablet 610, or computer 812 from FIG. 8). In some embodiments, the downloaded Mobility App modifies the device's original email program to allow attachments of files.

In 2012, open the Mobility-enabled email program on the user device. Then, Select “Attach Files” 2014 from the email program menu. Next, in 2016, select either “from internal device memory” (e.g., from devices 510, 610 and/or 812) or “from CardDrive memory” (e.g., flash memory 250 of FIG. 2 or 3).

In 2017, if “Internal Device memory” is selected, the email application will open a list of the internal folders, photos, documents, etc. and user select the correct folder then open and select the individual photos or documents and press “Attach” when actual file is selected, and file will be attached instantly to the email message. File is not encrypted. In some embodiments, if user desires the file to be encrypted then the user may first save the selected file into the CardDrive and then select and “Attach” the same file in its encrypted form to the email, as described in the below process.

In 2018, if “CardDrive memory” is selected (e.g., flash memory 250), the CardDrive present a list of the encrypted and locked folders and files. User will then select the appropriate folder/file to be attached 2020. Press “Attach” once file is selected. File will be attached to the message in its encrypted secured form 2022.

The foregoing description illustrates various embodiments of the present invention along with examples of how aspects of the present invention may be implemented. The above examples and embodiments should not be deemed to be the only embodiments, and are presented to illustrate the flexibility and advantages of the present invention. Based on the above disclosure and the following claims, other arrangements, embodiments, implementations and equivalents will be evident to those skilled in the art and may be employed without departing from the spirit and scope of the invention.

What is claimed is:

1. A storage device, comprising:
a case having a plurality of substantially planar walls defining an interior compartment;
a microcontroller unit;
an input/output interface in communication with the microcontroller unit;
a plurality of device interfaces in communication with the input/output interface, each interface configured for communicating with a different type of external device;
a memory for storing digital files;
an encryption module for encrypting the files stored in the flash memory; and
a wireless transceiver in communication with the MCU, said wireless transceiver configured for sending and receiving wireless signals,
wherein said microcontroller unit, interfaces, memory, encryption module, and wireless transceiver are housed within the interior compartment of the case.

2. The storage device of claim 1, further comprising:
a GPS module in communication with the wireless transceiver, said GPC module for tracking a location of the storage device; and
an alert notification module in communication with the MCU and the wireless transceiver, said alert notification module including instructions for sending alerts through the wireless transceiver to a user in response to an event detected communicated by the MCU.

3. The storage device of claim 2, wherein the event is an unauthorized attempt to access the storage device.

4. The storage device of claim 2, wherein each of the plurality of device interfaces comprises a selectively deployable connector configured to communicate with an external device having a port for receiving the selectively deployable connector.

5. The storage device of claim 4, wherein the external device is any of a mobile phone, a tablet computer, a computer, a television, a monitor, a speaker, or a camera.

6. The storage device of claim 5, wherein the plurality of device interfaces comprises an Android connector and an Apple connector.

7. The storage device of claim 4, wherein each selectively deployable connector may be retracted within the case for storage and individually extended from the case when the connector is to be connected to a compatible external device.

8. The storage device of claim 7, wherein each selectively deployable connector is coupled with a slide member configured to be selectively moved by a user to extend and retract the corresponding connector.

9. The storage device of claim 2, wherein each of the plurality of device interfaces comprises a wireless interface configured to communicate with a different type of external device.

10. The storage device of claim 9, wherein the external device is an Android mobile device, an Apple mobile device, a computer, a television, a monitor, or a speaker.

11. The storage device of claim 2, wherein the MCU is adapted to communicate with other storage devices to form a local private network of storage devices, wherein each storage device in the network of storage devices is configured for secure communications with a specific set of authorized users.

12. The storage device of claim 11, wherein the MCU is configured to automatically share files stored in the memory with a second storage device in the local private network when the storage device and the second storage device are within a communication range of each other.

13. The storage device of claim 12, wherein the MCU is configured to communicate with the other storage device through the input/output interface or the wireless transceiver.

14. The storage device of claim 12, wherein the communication range is determined by a communication protocol used by the device.

15. The storage device of claim 14, wherein the communication protocol is any of WiFi, Bluetooth, infrared, or Zigbee.

16. The storage device of claim 15, wherein the storage device is configured to share the files stored within the memory with the second storage device.

17. The storage device of claim 2, wherein
the input/output interface is configured to communicate with a mobile device, and
the MCU is configured to communicate with a software application on the mobile device, said software application configured to provide configuration instructions to the MCU and to present information regarding files stored in the memory to a user of the mobile device.

18. A private network, comprising:
a plurality of storage devices, each storage device comprising:
a microcontroller unit;
an input/output interface in communication with the microcontroller unit;
a plurality of device interfaces in communication with the input/output interface, each interface configured for communicating with a different type of external device;
a memory for storing digital files;
an encryption module for encrypting the files stored in the flash memory; and
a wireless transceiver in communication with the MCU, said wireless transceiver configured for sending and receiving wireless signals, and
a GPS module in communication with the wireless transceiver, said GPC module for tracking a location of the storage device; and
an alert notification module in communication with the MCU and the wireless transceiver, said alert notification module including instructions for sending alerts through the wireless transceiver to a user in response to an event detected communicated by the MCU;
wherein each storage device in the network is configured to encrypt and store files received from a corresponding mobile device, and
wherein each storage device in the network is configured to share its encrypted and stored files with other storage devices in the network.

19. The private network of claim 18, wherein each storage device in the plurality of storage devices are configured to communicate with the other storage devices using a short range communication protocol.

20. The private network of claim 19, wherein the short range communication protocol is any of WiFi, Bluetooth, infrared, or Zigbee.
